(19) United States
(12) Patent Application Publication
(10) Pub. No.: US 2022/0280988 A1
(43) Pub. Date: Sep. 8, 2022

(54) SPILL CONTAINMENT SYSTEM AND METHOD

(71) Applicants: Darrell Wayne Hagar, Bakersfield, CA (US); Cheryl Joann Hagar, Bakersfield, CA (US); Dylan Wayne Hagar, Bakersfield (US); Jordan Lewis Hagar, Bakersfield, CA (US)

(72) Inventors: Darrell Wayne Hagar, Bakersfield, CA (US); Cheryl Joann Hagar, Bakersfield, CA (US); Dylan Wayne Hagar, Bakersfield (US); Jordan Lewis Hagar, Bakersfield, CA (US)

(73) Assignee: DOBY HAGAR TRUCKING, INC., Shafter, CA (US)

(21) Appl. No.: 17/385,272

(22) Filed: Jul. 26, 2021

Related U.S. Application Data
(60) Provisional application No. 63/158,287, filed on Mar. 8, 2021.

(51) Int. Cl. B08B 17/02; F16N 31/00

(52) U.S. Cl. CPC B08B 17/025; F16N 31/006

(57) ABSTRACT

A spillage containment system is provided. The spillage containment system is designed to receive heavy equipment, e.g., for stowage, and to catch and contain any liquid or other debris that the heavy equipment may leak (e.g., oil or other environmentally harmful chemicals). The system includes a base large enough to receive the heavy equipment, and left, right, and back side walls. The system also includes a front drive-over device including an upward ramp opposing a downward ramp. The heavy equipment may drive over the drive-over device to be placed on the base. The drive-over device, and the left, right, and back sidewalls define a sealed inner volume within which the heavy equipment may be stowed.

### FIELD OF THE INVENTION

This invention relates to hazardous material containment systems, including spill containment systems for heavy equipment.

### BACKGROUND

Facilities that store hazardous materials are required to ensure that federal and state level standards are met with regards to the containment of the materials. In some instances, the hazardous materials are contained within trucks or other types of heavy equipment (e.g., fuel trucks). These trucks are typically parked for extended periods of time at facilities and precautions must be taken to ensure that hazardous liquids that may leak from such trucks are contained and do not contaminate the soil and water in the area beneath the trucks.

For example, the Environmental Protection Agency (EPA) and the Occupational Safety and Health Administration (OSHA) both require compliance to strict regulations for such storage systems.

In these instances, containment systems may be placed beneath the trucks or heavy equipment to catch hazardous materials that may spill from the trucks. The containment systems typically comprise a base plate with side walls to contain the spilled fluids. However, the containment systems currently available are typically constructed of plastic that often spring leaks thereby allowing the hazardous materials to escape. Other types of containment systems require assembly once the truck is parked thereby increasing time and cost of use.

Accordingly, there is a need for a spill containment system that is not prone to leaks and that enables a truck or other heavy equipment to drive onto the system without the need for assembly.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows aspects of a spill containment system in accordance with exemplary embodiments hereof;

FIG. 2 shows aspects of a base assembly in accordance with exemplary embodiments hereof;

FIGS. 3-6 show aspects of a drive-over device in accordance with exemplary embodiments hereof;

FIGS. 7-8 show aspects of vertical supports in accordance with exemplary embodiments hereof;

FIGS. 9-11 show aspects of vertical supports configured with drive-over devices in accordance with exemplary embodiments hereof;

FIG. 12 shows aspects of traction devices configured with a drive-over device in accordance with exemplary embodiments hereof;

FIG. 13 shows aspects of a drive-over device in accordance with exemplary embodiments hereof;

FIG. 14 shows aspects of a drive-over device in accordance with exemplary embodiments hereof; and

FIG. 15 shows aspects of a spill containment system including securing mechanisms in accordance with exemplary embodiments hereof.

### DETAILED DESCRIPTION OF EXEMPLARY EMBODIMENTS

In general, the system and method according to exemplary embodiments hereof includes a spill containment system 10. In some embodiments, the spill containment system 10 is used in conjunction with heavy equipment such as fuel trucks, oil filled equipment, truck washing decks, or any other equipment that may leak hazardous liquids. The system 10 generally includes a base plate upon which the equipment may rest, and side walls to contain any liquid that may leak from the equipment onto the base plate. In some embodiments, the system includes a novel drive-over portion allowing trucks to drive onto the system directly. The system includes other aspects and elements as will be described herein.

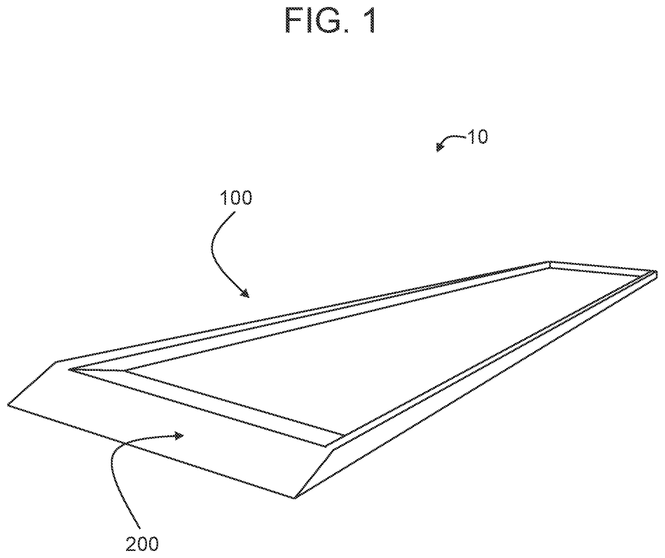

In one exemplary embodiment hereof as shown in FIG. 1, the spill containment system 10 includes a base assembly 100 and a drive-over device 200. The system 10 also may include other components or elements as necessary for it to fulfill its functionalities as described herein or otherwise.

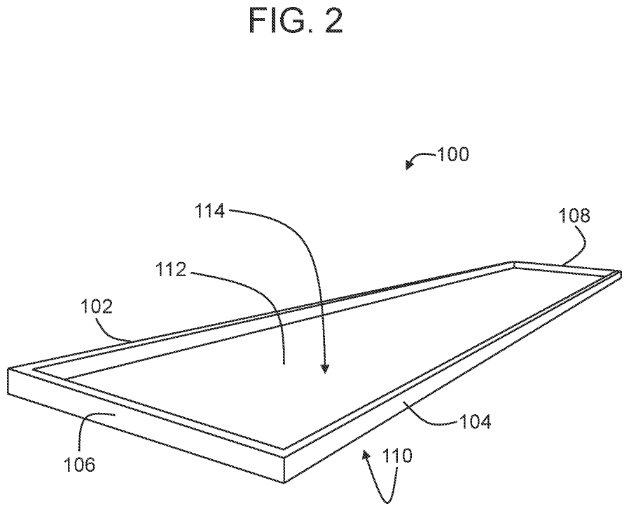

As shown in FIG. 2, the base assembly 100 generally includes a left side wall 102, a right side wall 104, a front wall 106, a back wall 108, and a bottom 110 including a topside surface 112. The base assembly 100 includes an inner volume 114 defined by the left wall 102, right wall 104, front wall 106, back wall 108 and inner surface 112. In this way, the base assembly 100 may be formed as an open-top rectangular cuboid. Note that in some embodiments described in other sections, the front wall 102 is replaced by a drive-over device 200.

While the perimeter of the base assembly 100 is depicted as being generally rectangular in shape (e.g., as having a rectangular footprint), it is understood that the assembly 100 may be formed in any suitable shape or any suitable combination of shapes.

In some embodiments, the base assembly 100 is formed of metal such as steel or other suitable metal(s), but it is understood that the base assembly 100 may be formed using other materials such as wood, plastic, composite materials, other materials, and any combinations thereof.

In some embodiments, the bottom 110 of the assembly 100 comprises a steel plate (e.g., 0.25″ thick steel), and the left 102, right 104, front 106, and back walls 108 may be formed using rectangular steel tubing (e.g., 2″×6″ rectangular tubing) welded or otherwise secured at the perimeter of the bottom 110 and on the topside surface 112. It is preferable that the walls extend about the bottom's entire perimeter and be attached to the topside surface 112 in a watertight configuration. In this way, the inner perimeter of the inner volume 114 is sealed. Being made of metal, any leaks that develop may be sealed using welding or other similar techniques. In this way, any liquid that spills into the inner volume 114 is held within the inner volume 114 until purposely removed. In some embodiments, the assembly 100 is designed to hold up to 100,000 lbs. without losing its physical integrity.

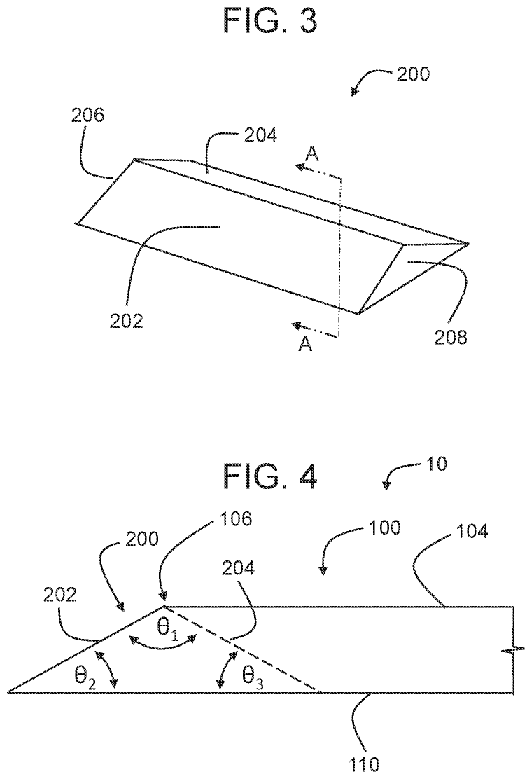

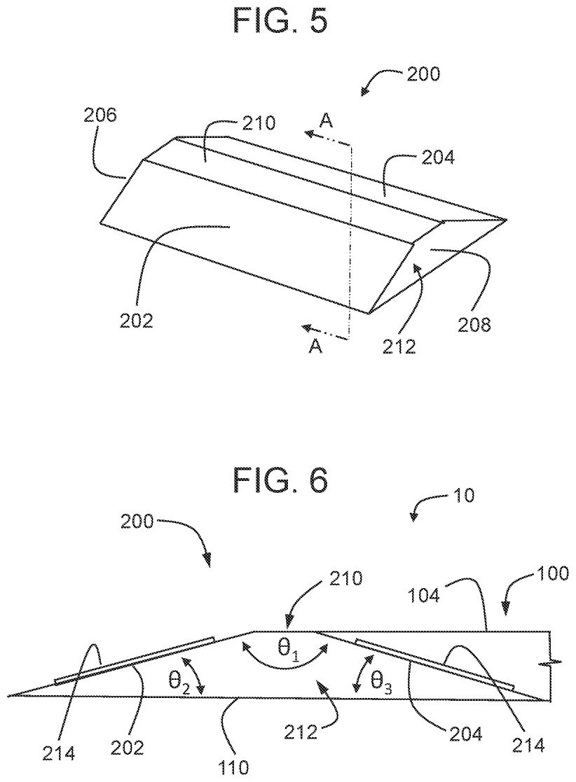

In some embodiments as shown in FIGS. 3-4, the drive-over device 200 is generally formed as a triangular prism with a front ramp 202 and a back ramp 204 and left 206 and right sides 208. In other embodiments as shown in FIGS. 5-6, the drive-over device 200 is generally formed as a trapezoidal prism with a top 210, a front ramp 202, a back ramp 204 and left 206 and right sides 208.

As shown in FIG. 4 (taken from the perspective of cutlines A-A in FIG. 3), the apex of the cross-section of the drive-over device 200 may be formed at an angle θ₁, with the front adjacent angle formed at θ₂ and the back adjacent angle formed at θ₃. In some embodiments, the cross-section of the device 200 may be formed as an isosceles triangle with the length of the front ramp 202 generally equaling the length of the back ramp 204. In this case, θ₂ may generally be equal to θ₃. However, this may not be required.

In some embodiments, θ₁ is about 90°-170° with θ₂ and θ₃ equaling about 5°-45°. In a preferred embodiment, θ₁ is about 150°-170° and θ₂ and θ₃ are each about 5°-15°, and more preferably, θ₁ is about 160° and θ₂ and θ₃ are each about 10°. It is understood that the angles θ₁, θ₂, and θ₃ may be formed at any suitable angles and that the scope of the system 10 is not limited in any way by the angles θ₁, θ₂, and θ₃.

In some embodiments as shown in FIGS. 1 and 4, the drive-over device 200 replaces the front wall 106 of the base assembly 100. For example, the front 106 wall of the base assembly 100 may be omitted and the drive-over device 200 may be installed instead. Accordingly, it may be preferable that the length of the drive-over device 200 from its left 206 to its right 208 generally match the width of the base assembly 100 between its left and right sides 102, 104. It also may be preferable that the height of the device 200 at its apex generally matches (or is greater than) the height of the left and right sides 102, 104. In this way, the drive-over device 200 may replace the front wall 106 of the base assembly 100 while performing its functionalities (e.g., disallowing liquid to inadvertently escape the inner volume 114). In this embodiment, the inner perimeter of the inner volume 114 is defined by the drive-over device 200, the left side wall 102, the right side wall 104, and the back side wall 108.

In some embodiments, the drive-over device 200 is integrated with (e.g., formed over) the front 106 wall of the base assembly 100. For example, the top edge of the front ramp 202 may be secured to the top of the base's front wall 106 (e.g., to the forward top corner of the front wall 106) with the ramp 202 extending downward and outward from the front wall 106 in a forward direction (away from the base assembly 100). Similarly, the top edge of the back ramp 204 may be secured to the base's front wall 106 (e.g., to the inner top corner of the front wall 106) with the ramp 204 extending downward and backward from the front wall 106 and into the inner volume 114. It may be preferable that the bottom edges of the front and back ramps 202, 204 terminate at horizontal levels generally equal to the level of the base assembly's bottom 110. In this way, the system 10 as a whole may include a generally flat bottom 110 from end-to-end and side-to-side.

In some embodiments, the front ramp 202 and the back ramp 204 of FIGS. 3-4 are formed together from a single piece (e.g., of metal plate) by bending the piece to form the front ramp 202, the top apex angle θ₁, and the back ramp 204 together.

In other embodiments, the front ramp 202, the top 210, and the back ramp 204 of FIGS. 5-6 are formed together from a single piece (e.g., of metal plate) by bending the piece to form the front ramp 202, the top 210, and the back ramp 204 with the front ramp 202 and back ramp 204 offset by the angle θ₁. Note that the top 210 may include a slight convex curvature and/or rounded transitions between itself and the front and back ramps 202, 204. In some embodiments, the top section 210 may extend about 1″-6″ between the front and back ramps 202, 204, and preferably about 3″. The top section 210 may facilitate easier production of the device 200 and/or may provide improved traction between the tires of the heavy equipment (when in use) and the top of the device 200 as the tires pass between the front ramp 202 and the back ramp 204.

In any of the embodiments of the drive-over device 200, the front ramp 202 may be referred to as an upward extending ramp given that it generally extends upward from left to right as shown in FIGS. 4 and 6, and the back ramp 204 may be referred to as a downward extending ramp given that it generally extends downward from left to right as shown in FIGS. 4 and 6. Accordingly, in some embodiments, the drive-over device 200 may be referred to as being formed by a upward extending ramp 202 followed by (e.g., opposing) a downward extending ramp 204.

In any of the embodiments, the left side wall 102 and the right side wall 104 towards the front 106 of the system 10 are formed to correspond to the downward angle θ₃ of the back ramp 204 such that the forward portions of the side walls 102, 104 may mate (e.g., abut) with the back ramp 204 as shown in FIGS. 4 and 6. It is preferable that the forward portions of the walls 102, 104 are attached to the corresponding left and right sides of the back ramp 204 (e.g., welded) so that a liquid-proof seal is provided in this area. In this way, the entire inner perimeter of the inner volume 114 is sealed. It also is contemplated that the left and right side walls 102, 104 extend beside and overlap the left and right sides 206, 208 of the drive-over device 200, respectively, and that the side walls 102, 104 are attached thereto (e.g., by welding). In general, it is understood that the forward portions of the side walls 102, 104 are attached to the drive-over device 200 in such a way to provide a sealed inner volume 114.

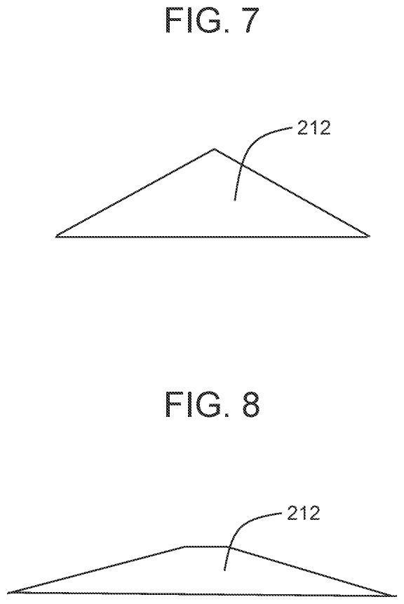

In some embodiments, the drive-over device 200 includes vertical supports 212 that provide vertical support to the front and back ramps 202, 204, and/or the top 210 (when included). In some embodiments, the supports 212 include metal plates (e.g., 0.25″ thick metal plates) formed to generally match the side cross-sectional shape of the drive-over device 200. For example, as shown in FIG. 7, the vertical support 212 includes a triangular shaped plate that matches the triangular shaped cross-section of the drive-over device 200 of FIGS. 3-4. In another example as shown in FIG. 8, the vertical support 212 includes a trapezoidal shaped plate that matches the trapezoidal shaped cross-section of the drive-over device 200 of FIGS. 5-6.

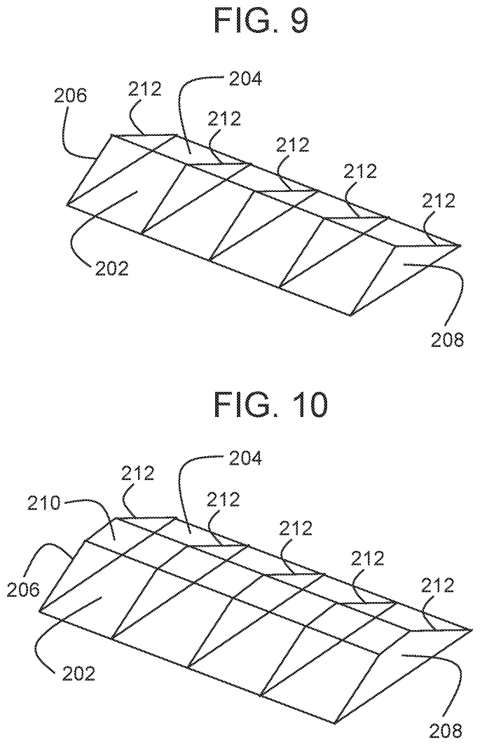

In some embodiments as shown in FIG. 9 for the drive-over device 200 of FIGS. 3-4, the supports 212 are aligned upright and sequentially underneath the front and back ramps 202, 204 at discreet locations ranging from the left side 206 to the right side 208. Note that the front and back ramps 202, 204 are depicted as see-through for clarity. In one example as shown, a first vertical support 212 is located at the left side 206 of the drive-over device 200, a second vertical support 212 is located at the right side 208 of the drive-over device 200, and three vertical supports 212 are located at spacings between the left side 206 and the right side 208. In this way, the plurality of vertical supports 212 are arranged to provide vertical support to the front and back ramps 202, 204 from the left side 206 to the right side 208 and therebetween.

In some embodiments as shown in FIG. 10 for the drive-over device 200 of FIGS. 5-6, the supports 212 are aligned upright and sequentially underneath the front ramp 202, the top 210, and the back ramp 204 at discreet locations ranging from the left side 206 to the right side 208. Note that the front and back ramps 202, 204 and the top 210 are depicted as see-through for clarity. In one example as shown, a first vertical support 212 is located at the left side 206 of the drive-over device 200, a second vertical support 212 is located at the right side 208 of the drive-over device 200, and three vertical supports 212 are located at spacings between the left side 206 and the right side 208. In this way, the plurality of vertical supports 212 are arranged to provide vertical support to the front ramp 202, the top 210, and the back ramp 204 from the left side 206 to the right side 208 and therebetween.

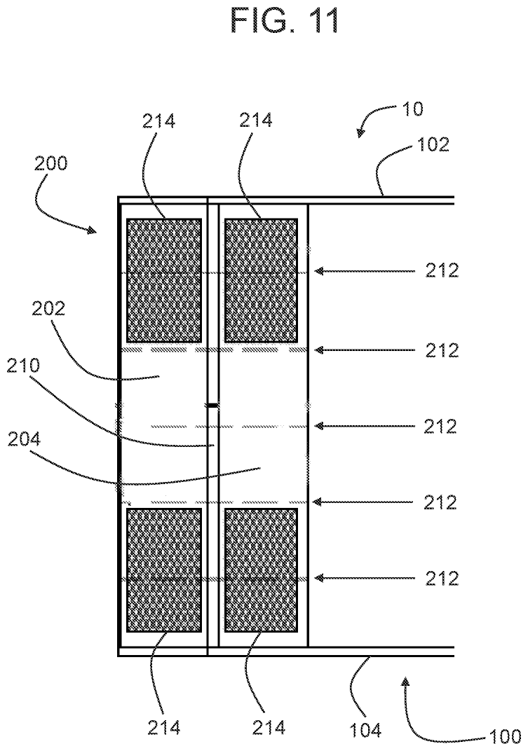

FIG. 11 shows a topside view of the front ramp 202, the top 210, and the back ramp 204 depicting exemplary locations of the vertical supports 212. In a preferred embodiment, five supports 212 are secured within the drive-over device 200 at equidistant spacings. However, it is understood that any number of stiffeners 212 may be used at any locations with respect to the device 200.

It is understood that the examples described above are meant for demonstration and that the drive-over device 200 may include other types of vertical supports to support the front and back ramps 202, 204, and the top 210 (when included), such as, without limitation, vertical beams, and other types of supports. It also is understood that while the vertical supports 212 are shows as generally aligned parallel with one another, the supports 212 may be arranged in any orientations. It also is understood that any number of supports 212 may be used at any spacings and/or locations.

In some embodiments, the vertical supports 212 are secured to the underneath sides of the front and back ramps 202, 204, and to the underneath side of the top 210 (when included) by welding, bolts, other attachment mechanisms and/or methods, and any combinations thereof.

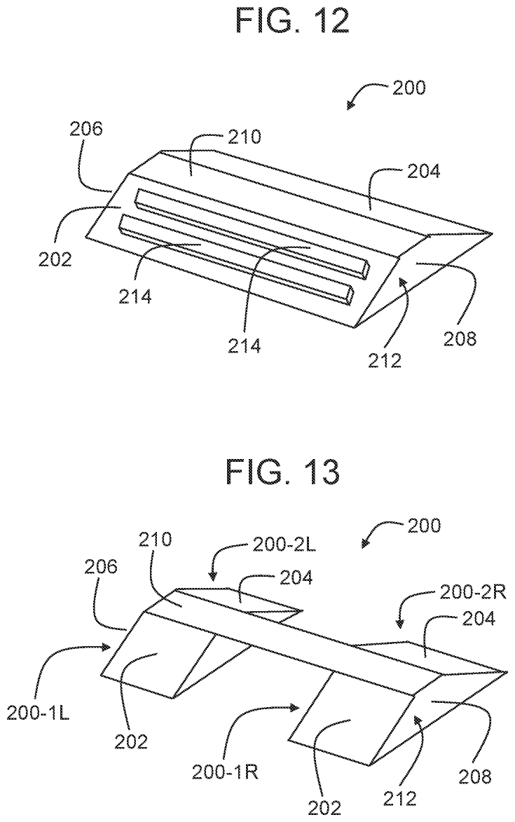

In some embodiments as shown in FIGS. 6 and 11, the top surfaces of the front ramp 202 and/or of the back ramp 204 include traction devices 214. The traction devices 214 may comprise a layer of textured metal, grating, rubber, plastic, composite materials, other suitable materials, and any combinations thereof. The traction devices 214 may each include a sheet of material, as well as discreet elements attached to the top surfaces of the ramps 202, 204. For example, the traction devices 214 may include sections of metal grating welded to the top surfaces of the ramps 202, 204 as shown in FIG. 11. In another example as shown in FIG. 12, the traction devices 214 may include individual sections of rods, tubing, brackets, and/or other elongate elements aligned to extend from the left side 206 to the right side 208 or any portions thereof. While the traction devices 214 (the sections of rectangular tubing in this example) are shown to extend continually from the left 206 to the right 208, it is understood that the devices 214 may extend in sections thereof, e.g., in the left and right areas upon which the tires of the heavy machinery may engage the drive-over device 200 as shown in FIG. 11. It also is understood that the devices 214 may include any number of elements (e.g., any number of sections of tubing) in any locations on the front ramp 202, the back ramp 204, and the top 210 (when included). In this way, the traction devices 214 may provide traction between the tires of the heavy equipment (when in use) and the top surfaces of the ramps 202, 204 and the top 210 to minimize slippage (e.g., when wet or frozen).

In some embodiments as shown in FIG. 13, the drive-over device 200 may comprise a first portion 200-1 and a second portion 200-2, that together form the device 200. For example, the first portion 200-1 may be formed as a triangular prism with a cross-sectional shape formed as a right triangle. In this case, the hypotenuse of the first portion's cross-section may generally form the front ramp 202 as shown. Similarly, the second portion 200-2 also may be formed as a triangular prism with a cross-sectional shape formed as a right triangle, and with its hypotenuse generally forming the back ramp 204. In this way, the front portion 200-1 may be abutted and attached (e.g., welded) to the front surface of the base assembly's front wall 106 extending in a forward direction, and the second portion 200-2 may be abutted and attached (e.g., welded) to the inner surface of the base assembly's front wall 106 extending into the inner volume 114. As shown in FIG. 13, this configuration generally forms a base assembly 100 with a front drive-over device 200. It should be noted that in this configuration, the length of the drive-over device portions 200-1, 200-2 from their left 206 to their right 208 need not necessarily match that of the width of the base assembly 100 between its left and right sides 102, 104 because the front wall 106, being intact, will act to seal the inner volume 114. However, in some embodiments it may be preferable.

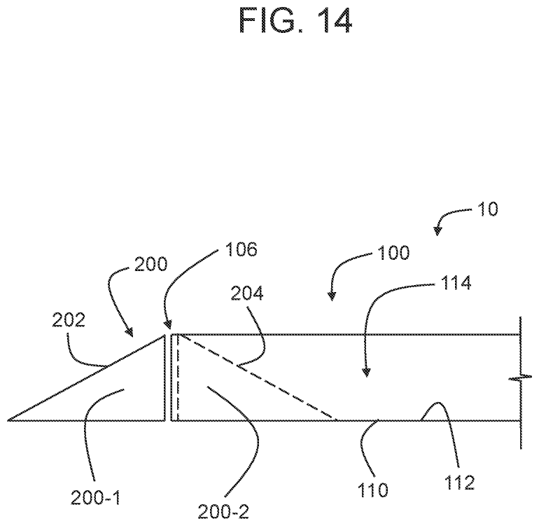

In other embodiments as shown in FIG. 14, the first portion 200-1 may include a left first portion 200-1L and a right first portion 200-1 R, each positioned to support the left and right wheels, respectively, of the equipment being placed into the containment system 10 as the equipment is driven onto the drive-over device 200 from outside the system 10. Similarly, the second portion 200-2 may include a left second portion 200-2L and a right second portion 200-2R, each positioned to support the left and right wheels, respectively, of the equipment being placed into the containment system 10 as the equipment is driven over the drive-over device 200 and into the containment system 10.

In some embodiments, the system 10 may include a second drive-over device 200 configured with its back 108. It is understood that all of the descriptions of all of the embodiments provided herein pertaining to a drive-over device 200 configured with the front 106 of the base assembly 200 also may pertain to a drive-over device 200 configured with the back 108 of the base assembly 200, and to avoid duplicity, the descriptions need not be repeated here.

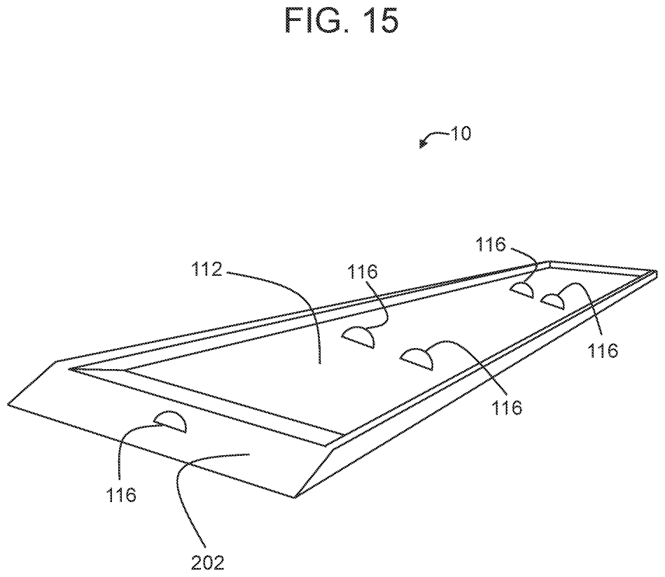

In some embodiments as shown in FIG. 15, the system 10 includes one or more securing mechanism 116 adapted to enable a crane or other moving apparatus to grip the securing mechanism 116 to move or otherwise position the system 10. In one example, the system 10 may include four securing mechanisms 116 configured with the inner surface 112, with the first two mechanisms 116 located approximately one-third back between the front 106 and the back 108 of the system 10, and the second two securing mechanism 116 located approximately two-third back between the front 106 and the back 108. In some embodiments, the system 10 also may include a securing mechanism configured with the drive-over device 200 (e.g., on the top of the front ramp 202) for use in pulling or otherwise repositioning the system 10. In some embodiments, the securing mechanisms may include D-rings or other types of loops or attachment mechanisms. It is understood that the positioning of the securing mechanisms 116 described above is meant for demonstration and that the system 10 may include any number of securing mechanism(s) 116 in any suitable locations.

In some embodiments, the containment system 10 may be about 20′ long and about 8′ wide. In other embodiments, the containment system 10 may be about 48′ long. It is understood that the system 10 may be designed using any dimensions as necessary to provide the functionalities described herein to any type of equipment or fluid storage devices.

In Use

In one example, the spill containment system 10 is used to contain possible leakage of hazardous materials from fuel trucks. In this example, a fuel truck may drive onto and over the drive-over device 200 from the front and enter into the system's inner volume 114. Once entirely positioned within the system's inner volume 114, the truck may be parked and left. Because the truck may be positioned completely within the inner volume 114 of the containment system 10, any fluid or other debris that spills from the truck will be caught by the system 10 and held until purposely removed. In this way, the system 10 prevent the hazardous liquid from reaching the ground and polluting the soil and water beneath the truck.

In a second example, if the intent is to store a trailer within the containment system 10 while removing the towing vehicle, the truck may enter the containment system as described above, disconnect itself from the trailer portion (with the trailer portion fully contained within the inner volume 114), and drive out the back 108 of the system 10. In this example, it may be preferable that the back 108 also be configured with a drive-over device 200 so that the truck may drive over the device 200 when exiting the containment system 10.

It is understood that the examples provided above are meant for demonstration and are non-limiting.

It is understood that any aspect or element of any embodiment of the system 10 described herein may be combined with any other aspect or element of any other embodiment to form additional embodiments all of which are within the scope of the system 10.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A spillage containment system comprising:
a base including a top side, a front end, a back end, a left side, and a right side, the base comprising a rigid material;
a left side wall configured with the top_side at the left side, a right side wall configured with the top_side at the right side, and a back side wall configured with the topside at the back end; and
an upward extending ramp configured with the front end and a downward extending ramp configured with the front end and opposing the upward extending ramp.

2. The spillage containment system of claim 1 wherein the drive-over device is formed as a triangular prism.

3. The spillage containment system of claim 1 wherein the upward extending ramp and the downward extending ramp form a trapezoidal prism.

4. (canceled)

5. The spillage containment system of claim 1 further comprising a traction device coupled to an upper surface of the upward extending ramp and/or to an upper surface of the downward extending ramp.

6. The spillage containment system of claim 5 wherein the traction device includes at least one of a metal grating, a rod, a tube, a bracket, and textured metal.

7. The spillage containment system of claim 1 further comprising a first securing mechanism coupled to the top side and located closer to the front end than to the back end and a second securing mechanism coupled to the top side and located closer to the back end than to the front end, the first and second securing mechanisms each including comprising an opening adapted to receive a hook.

8. The spillage containment system of claim 7 wherein the first and second securing mechanisms each include at least one of a loop, a ring, a hook, and a D-ring.

9. The spillage containment system of claim 1 wherein the upward extending ramp includes a front edge defining a lowest portion of the upward extending ramp and the downward extending ramp includes a rear edge defining a lowest portion of the downward extending ramp, the spillage containment system further comprising at least one vertical support configured beneath the first upward extending ramp and beneath the downward extending ramp and extending continuously from the front edge to the rear edge.

10. The spillage containment system of claim 9 wherein the at least one vertical support is formed as a triangle or as a trapezoid.

11. (canceled)

12. (canceled)

13. The spillage containment system of claim 1 wherein the upward extending ramp and the downward extending ramp are formed from a single piece.

14. The spillage containment system of claim 1 wherein the left side wall, the right side wall, and the back side wall are a first height, and the upward extending ramp and the downward extending ramp are a second height, and wherein the second height equals the first height.

15. A spillage containment system comprising:
a base including a top side, a front end, a back end, a left side, and a right side, the base comprising steel including a thickness of at least 0.25″;
a left side wall configured with the top_side at the left side, and a right side wall configured with the top side at the right side;
an upward extending ramp configured with the front end and a downward extending ramp configured with the front end and opposing the upward extending ramp.

16. The spillage containment system of claim 15 wherein the upward extending ramp and the downward extending ramp form a triangular prism or a trapezoidal prism.

17. The spillage containment system of claim 15 further comprising at least one traction device coupled to an upper surface of the upward extending ramp, and/or to an upper surface of the downward extending ramp;
wherein the at least one traction device includes at least one of a metal grating, a rod, a tube, a bracket, and textured metal.

18. The spillage containment system of claim 15 wherein the upward extending ramp includes a front edge defining a lowest portion of the upward extending ramp and the downward extending ramp includes a rear edge defining a lowest portion of the downward extending ramp, the spillage containment system further comprising at least one vertical support configured beneath the first upward extending ramp, and beneath the downward extending ramp and extending continuously from the front edge to the rear edge;
wherein the at least one vertical support is formed as a triangle or as a trapezoid.

19. (canceled)

20. (canceled)

21. The spillage containment system of claim 1 wherein the rigid material includes steel.

22. The spillage containment system of claim 1 wherein the topside is solid and unobstructed from above.

23. The spillage containment system of claim 1 wherein the rigid material includes a thickness that can withstand up to 10,000 pounds without deforming.

24. The spillage containment system of claim 15 further comprising a first securing mechanism coupled to the top side and located closer to the front end than to the back end and a second securing mechanism coupled to the top side and located closer to the back end than to the front end, the first and second securing mechanisms each including an opening adapted to receive a hook.

25. The spillage containment system of claim 24 wherein the first and second securing mechanisms each include at least one of a loop, a ring, a hook, and a D-ring.
